(19) United States
(12) Patent Application Publication
(10) Pub. No.: US 2023/0208646 A1
(43) Pub. Date: Jun. 29, 2023

(54) SYSTEM AND EXCHANGE FOR MANAGING RIGHTS OF PUBLICITY

(71) Applicant: HEX Holdings 2022, LLC, Wilmington, DE (US)

(72) Inventor: Michael KLEIN, Miami, FL (US)

(21) Appl. No.: 18/178,221

(22) Filed: Mar. 3, 2023

Related U.S. Application Data
(63) Continuation-in-part of application No. 17/858,022, filed on Jul. 5, 2022.
(60) Provisional application No. 63/217,983, filed on Jul. 2, 2021.

(51) Int. Cl. H04L 9/32

(52) U.S. Cl. CPC H04L 9/3236; H04L 2209/603

(57) ABSTRACT

A system and digital exchange for managing intangible personal rights includes at least a first and second object each including at least one object identifier, at least a first and second group of fractional cryptographic object data blocks each associated with the first and second objects, and a digital exchange. The fractional data blocks contain a value as well as a unique identifier and key associating the object data block with its respective object. Each data block is linked with a plurality of data blocks via cryptographic hashes. The digital exchange comprises a first user associated with at least one fractional object data block, a first table including at least one object and fractional object data blocks, and a second user. The first user authorizes the transfer of at least one fractional object data block to the second user and an exchange transaction is created to verify and authenticate the transfer.

### BACKGROUND

Rights of Publicity (“RoP”) are intangible legal rights that protect an individual's name, likeness, or other indicia of personal identity, such as a nickname, pseudonym, voice, signature, likeness, or photograph. Under state law throughout the United States, an individual can use his or her RoP for commercial benefit.

Typically, RoPs are licensed through sponsorship contracts. They inherently position RoPs at a disadvantage because of rigid contracting, a lack of true value evaluation, and access to a competitive open market. Long term contracts are cumbersome and lock-in individuals without the ability to fluctuate and adjust for growth of a person's brand based on market determinations.

The current RoP regime is even more challenging in a social media world with more avenues for creating a brand on the internet. A new generation of digital economy participants such as bloggers, influencers, gamers, online personalities, and upcoming athletes need ways to exploit their RoP in a more streamlined, transparent way. Moreover, with the changing online media landscape, traditional celebrities such as pro athletes, musicians, and businessmen need ways to digitize their RoPs more efficiently and in line with the changing media norms and technologies.

Accordingly, there is a need for a system and digital exchange for managing intangible personal rights. The system and exchange includes at least a first and second object each including an object value and at least one object identifier, at least a first and second group of fractional cryptographic object data blocks each associated with the first and second object, and a digital exchange. Each fractional object data block contains a value as well as a unique identifier and key associating the object data block with its respective object, wherein a sum of the value of each fractional cryptographic object data block of a group is equal to the value of its respective object. The fractional cryptographic object data blocks are linked with a plurality of data blocks via cryptographic hashes. Preferably, this includes a private centralized or semi-centralized ledger.

The digital exchange comprises a first user associated with at least one fractional object data block, a first table including at least one of objects and fractional object data blocks, and a second user. When used, the first user authorizes the transfer of at least one fractional object data block to the second user and an exchange transaction is created to verify and authenticate the transfer. The exchange transaction is recorded with a chain of a plurality of data blocks which are linked via a cryptographic hash. Preferably, this includes a private centralized or semi-centralized ledger.

In one embodiment, the object identifier includes at least one of an individual's name, image, likeness, nickname, pseudonym, voice, or signature. Further, the at least a first and second object each further include at least one attribute, wherein the at least one attribute is associated with the at least one object identifier. Preferably, the attribute includes at least one of an individual's age, gender, popularity rating, social media following, profession, awards, and experience in an industry.

In a second embodiment, the at least a first and second object value is adjustable, the object value being determined based on the at least one object identifier. Preferably, the object value adjusts based on weighting methods applied to one of the at least one object identifier and at least one attribute.

In another embodiment, the amount of fractional cryptographic object data blocks is determined according to an initial object value.

In yet another embodiment, the system further includes at least one whole cryptographic object data block comprising a plurality of the fractional cryptographic object data blocks. A whole cryptographic object data block represents a portion or all of the object value and is created when a single user on the exchange is associated with a threshold amount of fractional cryptographic data blocks of a group of blocks.

### BRIEF DESCRIPTION OF THE FIGURES

Other objects and advantages of the invention will become apparent from a study of the following description when viewed in the light of the accompanying drawing, in which:

FIG. 1 is a flow chart of a method for a system and exchange for managing intangible rights according to the present disclosure;

FIGS. 2 and 3 are schematics of the system and exchange of FIG. 1;

FIG. 4 is an embodiment of a login screen for a system and exchange according to the present disclosure;

FIG. 5 is an embodiment of a table showing exchangeable objects according to the present disclosure;

FIG. 6 is an embodiment of a table showing objects that have been exchanged according to the present disclosure;

FIG. 7 is an embodiment of a table showing objects associated with a user of an exchange according to the present disclosure; and

FIG. 8 is an embodiment of a table displaying the contents of a digital wallet according to the present disclosure.

### DETAILED DESCRIPTION

The exemplary embodiments are described below with reference to the drawings. These drawings illustrate details of embodiments that implement the modules, methods, and computer programs described disclosed. The methods and computer program product may be provided on any machine-readable media for accomplishing the described operations. The embodiments may be implemented using an existing computer processor, or by a special purpose computer processor incorporated for this or another purpose.

The embodiments described herein are implemented in a networked environment using logical connections to one or more remote computers having processors. These include commonplace computer networks, intranets and the internet and may use a wide variety of different communication protocols. The embodiments are implemented via distributed computing environments where tasks are performed by local and remote processing devices that are linked through a communication network. In a distributed computing environment, program modules may be located in both local and remote memory storage devices.

The embodiments of the disclosed system and exchange are implemented through general-purpose computing devices such as a computer that includes a processing unit, a system memory, and a system bus that connects system components including the memory to the processing unit. The computer and processor also includes machine-readable media, machine-executable instructions, data structures, program modules and other data for the computer.

The present disclosure provides a secure and verifiable way for an individual or entity to digitally manage RoPs through a digital system and exchange, which allows individuals to list, trade, sell and buy digital RoP rights. For the present system and exchange, those rights are handled via tokens with unique identifiers with the transfer and storage methods described herein to make the exchange of ownership in RoP easy and secure.

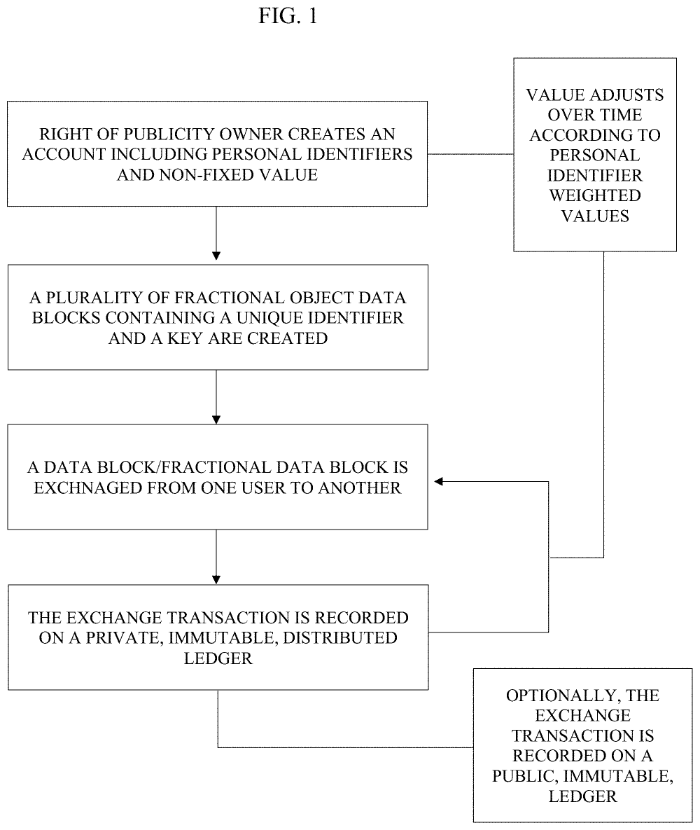

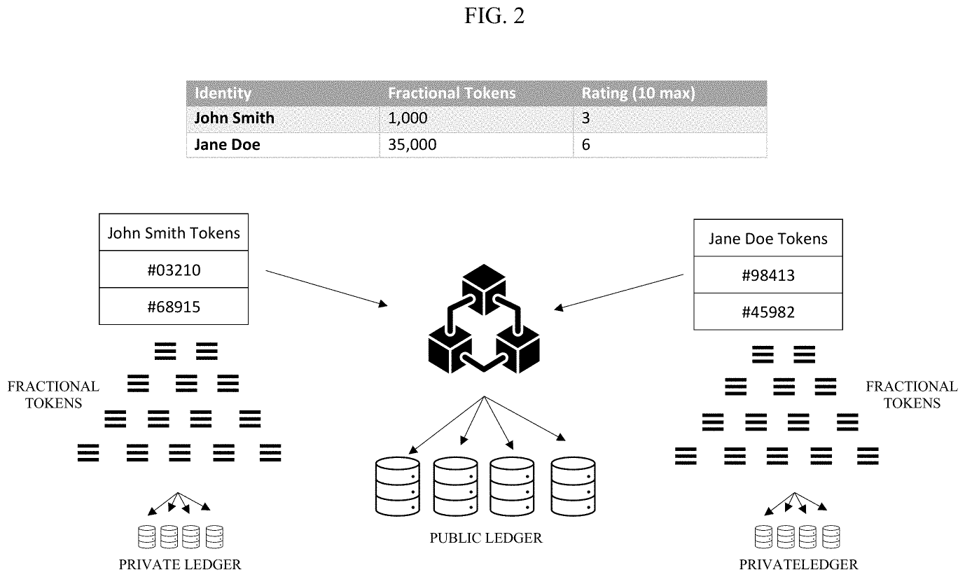

Referring to FIGS. 1-3, a method and schematic for a system and exchange are shown. A right of publicity owner, whether the public figure having the underlying rights or a person or entity that owns the underlying rights, creates an account that includes the rights. This is stored in the system as a first object with identifying attributes and an object value. The attribute includes at least one of an individual's age, gender, popularity rating, social media following, profession, awards, and experience in an industry. The object value is based on a value associated with the underlying right(s) of publicity, which continually adjusts based on weighting methods applied to the underlying rights and attributes. It will be understood by those with skill in the art that the different attributes will be weighted based on a desired level of importance, and that weighted amounts may vary over time.

A plurality of factional tokens are created to represent the object and rights. Each token includes a unique, cryptographic identifier and a key associating the token with the object an a value. The total fractional tokens that represent an object, and thus rights of publicity, amount to the object value, which may be the total monetary value associated with a right of publicity, or a portion of that value which is being offered on the exchange described in this disclosure. The unique token identifier ensures that tokens are secure and cannot be copied. The fractional tokens, also referred to as fractional data blocks, are recorded with a private ledger that uses cryptographic hashes to secure the data blocks. The data blocks could also be recorded with a public ledger.

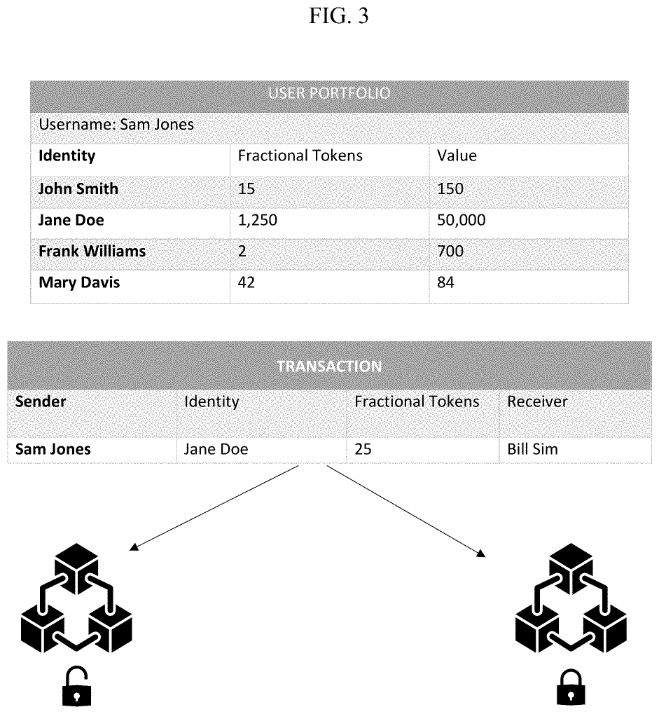

As shown in FIG. 3, once object and fractional data blocks are created, they can be exchanged within the exchange and system. Then once exchanged, they can be further exchanged as desired by the owner of the fractional data blocks. The exchange includes a first user associated with at least one of the fractional data blocks, a first table including object information and fractional object data blocks, and a second user. The first user authorizes the transfer fractional tokens to the second user and an exchange transaction is created to verify and authenticate the transfer. The exchange transaction is recorded with a chain of a plurality of fractional data blocks which are linked via a cryptographic hash. Preferably, this includes a private digital ledger, but it is also contemplated that transfers will be recorded on a public, immutable, distributed digital ledger.

The object identifier may include one or more attributes that records an individual's name, image, likeness, nickname, pseudonym, voice, or signature.

The amount of fractional cryptographic object data blocks is determined according to an initial object value. For instance, if an object value is equal to 10,000, there may be 10,000 fractional object data blocks each having a value of 1, there may be 1,000 fractional object data blocks each having a value of 10, or any number of fractional object data blocks with associated values that when summed with amount to the object value.

If a user owns, controls or otherwise is associated with a threshold amount of fractional data blocks associated with the same object, a whole object data block comprising a plurality of fractional data blocks may be created. For instance, one object may include 50,000 fractional data blocks associated with the object, and when a single user reaches a threshold level of ownership of fractional object data blocks, for instance 10,000, that user will have the option of creating a whole object data block to represent the 10,000 fractional blocks. The threshold requirement will vary, with some instances requiring all fractional data blocks of an object being owned by a single user.

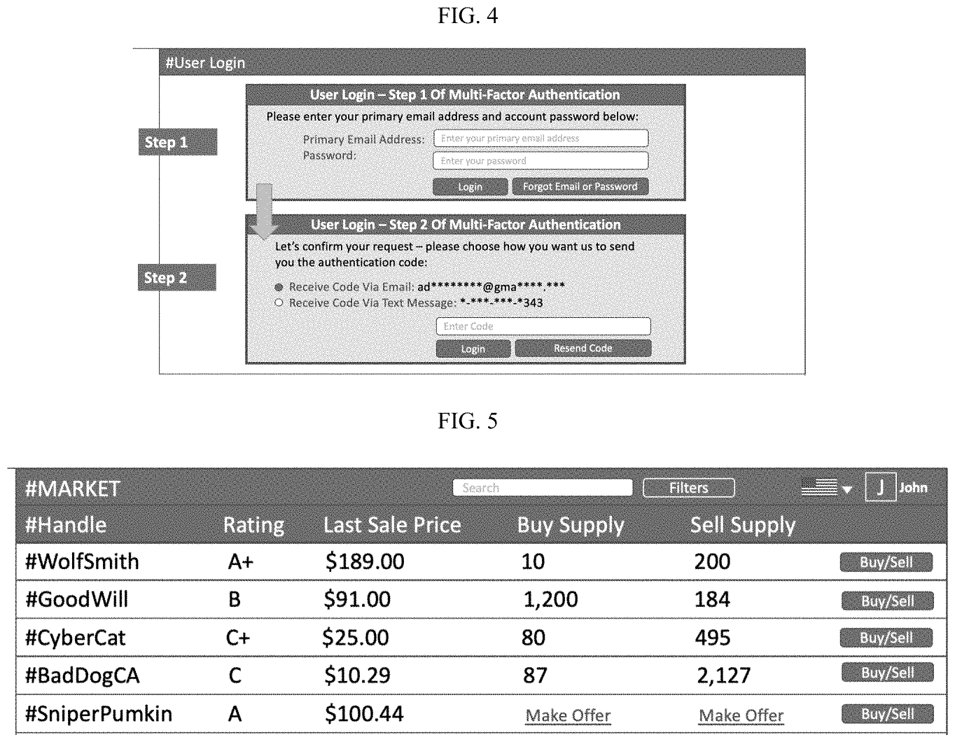

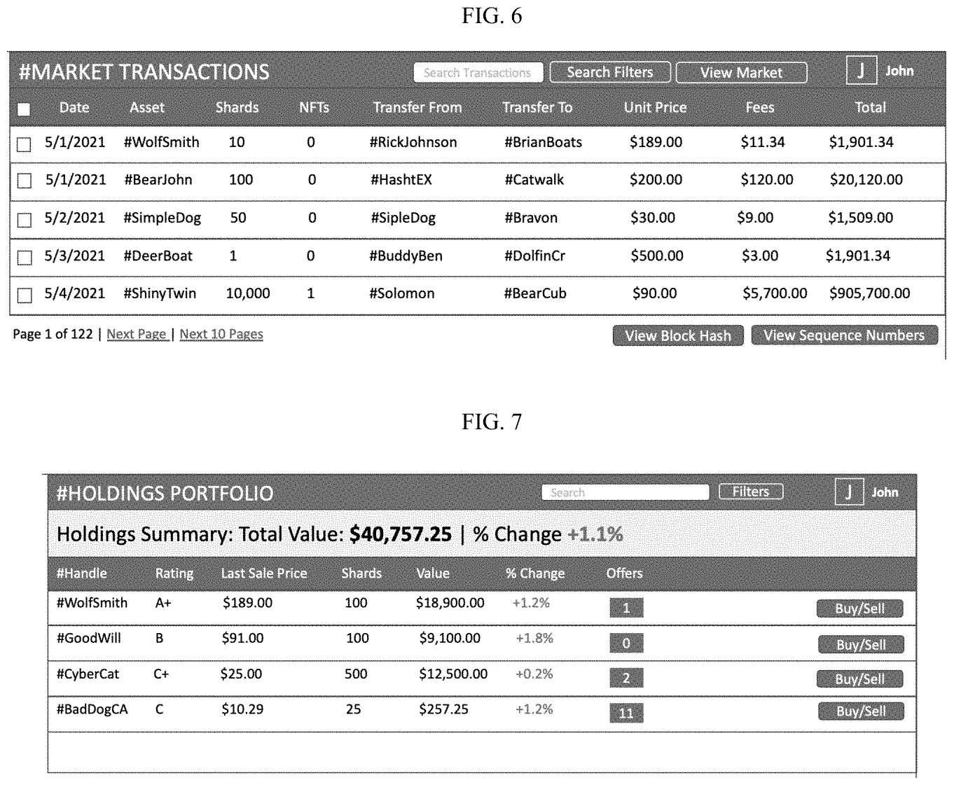

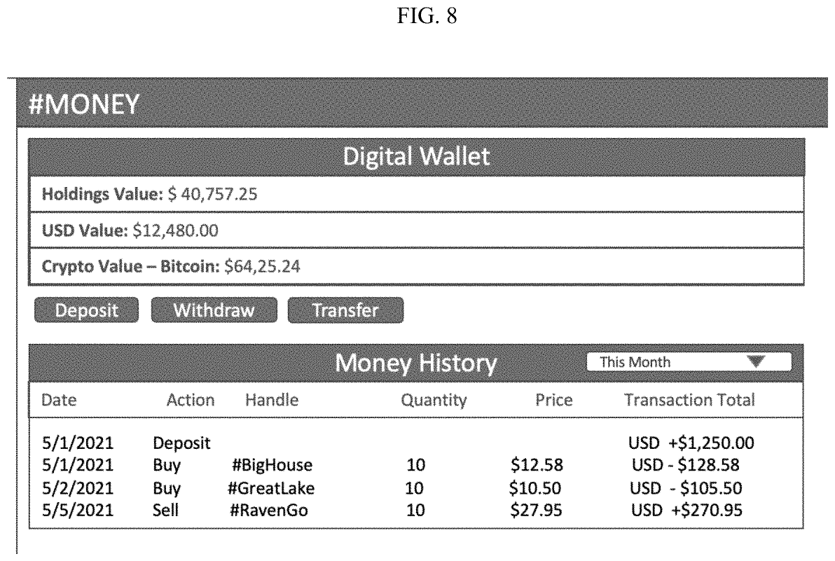

As shown in FIGS. 4-8, an individual manages his or her RoP for the present system and exchange by creating a system profile and obtaining fractional tokens within the exchange, the number of which are determined by a value of an individual's RoP. The fractional tokens are purchased by other system users and/or granted to users by individuals in which the RoP resides, by system administrators, or by a fractional token owner. Artificial intelligence is used to streamline the process and connect potential sellers with buyers.

The use of whole tokens and fractional tokens ensures security in the creation and exchange of RoP digital rights, which are exchanged and recorded through digital ledgers with the use of blockchain technology. Using such technology will allow for ease of valuation and fluctuation in the market value of the RoP of an individual, while also ensuring the tokens associated with that RoP are secure. Without such technology, a digital RoP exchange would be significantly more challenging to implement.

An individual lists his or her brand on the exchange if the individual (Right of Publicity Owner or RPO) meets certain eligibility criteria related to authenticating his or her identity and validating legal possession of the RoP. Once validated, the RPO is issued a user identifier, such as a hash handle, along with an initial system value and performance rating of the RoP. Preferably, the value and performance rating are computed via a system processor and algorithm which weighs factors relevant to the expected market value of the RoP. Previous initial valuations within the digital system and exchange, token exchanges and changes to valuation, in addition to specific attributes of the RPO are analyzed and compared via the algorithm to determine an initial value. It will be understood by those will skill in the art that other parameters relevant to rights of publicity generally and the RPO specifically could be considered, and each weighted factor can vary based on the desired importance of a factor. There is also a risk rating for each RPO, which is determined via similar means by system algorithms, and which may fluctuate throughout the listing and exchange of the RoP. The exchange maintains the rating throughout the life of a listing.

In one example, the exchange may assign a value of 1,000 to an RPO with 1,000 fractional tokens created to represent the total of the digital RoP available for the exchange. This may represent a percentage of the actual RoP value at the time of listing. To ensure the tokens are not overly diluted, there is a cap to the total number of tokens created for each RoP listed on the exchange.

Of the assigned tokens, there is preferably a percentage that is maintained by the digital system and exchange for managing the transactions within the exchange. For instance, when an object includes 10,000,000 fractional tokens, 50,000 of those tokens may be reserved for the digital system and exchange. Beyond this initial reservation, it is expected that the exchange will retain no further fractional tokens, thus providing ease of exchange between users.

The exchange ensures authenticity of ownership. All ownership certificate transactions are hosted directly by the exchange, and each token trade is recorded for ownership validation. In addition to a private ledger which can be viewed by administrators of the digital system and exchange, trades can optionally be tracked and recorded on a public ledger which can be accessed by all users.

Preferably, the RoP whole token and fractional token values are represented by a monetary value, such as the US Dollar, other similar territorial values, cryptocurrencies, or other such currencies. Ethereum is the preferred technology used to track and value the whole tokens and fractional tokens, but it will be understood by those with skill in the art that alternative technologies and values could be attributed to the tokens and fractional tokens without deviating from the spirit of the invention.

Once the value and performance rating are determined, the fractional tokens are listed on the exchange for users of the exchange to obtain. Users can use digital currency and/or previously purchased fractional tokens to purchase new fractional tokens or exchange owned fractional tokens with new ones, respectively. Purchase of fractional tokens can be authorized by the RPO, authorized by system administrators, or automatically reviewed and authorized via a system processor and program with computer readable instructions. Once a purchase is made, the purchaser's digital wallet and fractional token ownership will be updated to reflect the change. The purchaser now has a fractional token that is valued by the RoP value of the RPO which may increase in value based on the RPO's growth in his or her industry. If a fractional token owner no longer wishes to own certain RoP fractional tokens, the owner can sell or exchange them through the secure ledger, ensuring transactional security for the new owner of the fractional token and for the RPO.

The digital system and exchange manages all transactions between users related to the exchange trade order flow, including buy, sell and offer automation, through automated artificial intelligence processes. Preferably, artificial intelligence programs identify supply and demand gaps to facilitate matching buyers and sellers.

This digital system and exchange determines the value of a Rights of Publicity Owners by allowing the owner to digitize his or her brand and enable open market RoP trading to increase value and awareness, unlock brand potential, and ultimately monetize one's own RoP.

Such a system will allow for more individuals who, until now, could not capitalize on their RoP to do so, it will allow for third parties to participate in the exchange and monetization of RoPs, and it will streamline the entire RoP monetization process that has followed an outdated model.

Although the above description is in reference to a particular embodiment, it is to be understood that the embodiment is merely illustrative of the principles and applications of the present disclosure. It is therefore to be understood that numerous modifications may be made to the illustrative embodiment and that other arrangements may be devised and employed without departing from the spirit and scope of the present disclosure.

What is claimed is:

1. A system and digital exchange for managing intangible personal rights, comprising:
(a) at least a first and second object each including at least one object identifier and a value;
(b) at least a first and second group of fractional cryptographic object data blocks each associated with the at least a first and second cryptographic object data block, each fractional object data block containing a value and a unique identifier and a key associating the fractional object data block with its respect first or second object, wherein a sum of the value of each fractional cryptographic object data block of a group is equal to its respective object value, each fractional object data block of a group being linking to another object data block of the same group via cryptographic hashes; and
(c) A digital exchange, comprising:
(i) a first user associated with at least one of the fractional cryptographic object data blocks from the at least a first and second group;
(ii) a first table including at least one of objects and fractional object data blocks associated with the first user; and
(iii) a second user, wherein:
(1) the first user authorizes the transfer of at least one fractional object data block to the second user;
(2) an exchange transaction is created to verify and authenticate the transfer; and
(3) the exchange transaction is recorded with a chain of a plurality of data blocks, the plurality of data blocks linked via a cryptographic hash.

2. The system and digital exchange of claim 1, wherein the object identifier includes at least one of an individual's name, image, likeness, nickname, pseudonym, voice, or signature.

3. The system and digital exchange of claim 1, the at least a first and second object each further including at least one attribute, wherein the at least one attribute is associated with the at least on object identifier.

4. The system and digital exchange of claim 3, wherein the at least one attribute includes at least one of an individuals age, gender, popularity rating, social media following, profession, awards, and experience in an industry.

5. The system and digital exchange of claim 4, wherein the at least a first and second object value includes an initial value and a current value, the object initial value being based on the at least one object identifier when the object is created, the object current value being based on the at least one object identifier and varying over time.

6. The system and digital exchange of claim 5, wherein the object initial value is and the current value adjusts based on weighting methods applied to one of the at least one object identifier and at least one attribute.

7. The system and digital exchange of claim 7, wherein the amount of fractional cryptographic object data blocks associated with a cryptographic object data block is determined according to the object initial value.

8. The system and digital exchange of claim 7, wherein the exchange transaction is recorded with a private cryptographic ledger.

9. The system and digital exchange of claim 1, and further comprising at least one whole cryptographic object data block comprising a plurality of the fractional cryptographic object data blocks, wherein a whole cryptographic object data block represents a portion or all of the object value, the whole cryptographic object data block being, created when a single user on the exchange is associated with a predetermined amount of fractional cryptographic data blocks of a group of blocks.

10. The system and digital exchange of claim 9, wherein the first user of the digital exchange is associated with at least one of a whole cryptographic object data block and a fractional cryptographic object data block.

11. The system and digital exchange of claim 10, wherein the first table includes at least one of objects, whole object data blocks and fractional object data blocks associated with the first user.

12. The system and digital exchange of claim 11, wherein whole object data blocks are recorded on a public, immutable, distributed ledger.
